(19) United States
(12) Patent Application Publication
(10) Pub. No.: US 2009/0112136 A1
(43) Pub. Date: Apr. 30, 2009

(54) Manual device for massaging appendage muscles

(76) Inventors: Kevin Scott Litton, Sapporo (JP); Jonathan Scott Walsh, Sapporo (JP)

Correspondence Address: Kevin S. Litton, Chuo Ku, Sakaigawa 3-7-20, Asahiyama Garden Hills 203, Sapporo, 064-0943, JP

(21) Appl. No.: 12/286,209

(22) Filed: Sep. 30, 2008

Related U.S. Application Data
(60) Provisional application No. 61/000,196, filed on Oct. 25, 2007.

(51) Int. Cl. A61H 23/00

(52) U.S. Cl. 601/48

(57) ABSTRACT

One embodiment of a portable, manual, appendage muscle massager comprising a wrap (8) constricted by a tension-transfer member (10), such as a cable, and a manual actuator (14) which retracts the cable (10).

### CROSS-REFERENCE TO RELATED APPLICATIONS

This application claims the benefit of provisional patent application Ser. No. US 61/000,196 filed Oct. 25, 2007 by the present inventors, which is incorporated by reference.

### FEDERALLY SPONSORED RESEARCH

Not Applicable

### SEQUENCE LISTING OR PROGRAM

Not Applicable

### BACKGROUND OF THE INVENTION

1. Field

This application generally relates to personal care, specifically to personal massaging devices.

2. Prior Art

Previously, many massaging devices have been introduced that are portable and easy to use, many of which can be found in stores or on websites that sell personal care products. The vast majority of these devices are for the neck and back. However, especially with the condition called Deep Vein Thrombosis (commonly referred to as Economy Class Syndrome) on the rise, there is a need for a portable, easy to use device for appendage muscles, such as the calf muscle.

One commonly used device for appendage muscles is the compression stocking, which is a static device, as opposed to one which contracts and expands, and thus not a true massaging device.

Another concept is a portable device which works by sending electrical impulses to stimulate the muscle. This, again, is not a true massaging device. It also requires electricity, in the form of a battery, which can be inconvenient for many people, and the device may cost more than someone other than those already afflicted with deep vein thrombosis or at a high risk for this condition may be willing to spend.

Still another concept is a massaging device which requires a bladder filled with liquid or air with a pump to inflate and deflate the bladder at intervals to provide the massaging effect. However, most are cumbersome devices which are not portable and are cost prohibitive except for use in clinical environments. Even those which claim to be portable are so only in a loose definition of the word portable. These are also medical devices, rather expensive, and are primarily for those people already with deep vein thrombosis or those with a high risk of this condition.

### SUMMARY

In accordance with one embodiment, a portable, manual, non-electric, inexpensive device to massage appendage muscles.

### DRAWINGS—FIGURES

FIGS. 1A and 1B show an embodiment with one cable 10, one extension guide 12a, one internal guide 12b, and two springs 16.

FIGS. 2A and 2B show an embodiment with two cables 10 and a split extension guide 12a.

FIG. 3 shows an embodiment with one cable 10 with a solid grooved internal guide 12b.

FIG. 4 shows an embodiment with two cables 10, two separate extension guides 12a, a completely encircling wrap 8 with no gap 26, encased springs 16 adjacent to the cables 10, an actuator 14 wide enough to be operated by foot or be placed on a flat object such as a table, and no internal guide.

FIG. 5A shows an embodiment with a short, band or belt-like wrap 8 with a single cable 10, and protruding members 22.

FIG. 5B shows the simplest embodiment with only one cable 10 and an extension guide 12a.

FIG. 6 shows an embodiment with no internal guide as the cable 10 is encased within the wrap 8.

### DRAWINGS—REFERENCE NUMERALS

8 wrap 18 spring

10 tension-transfer member/cable

12a extension tension-transfer member guide

12b internal tension-transfer member guide

14 manual retracting device/actuator

16 wrap supporter

20 protective flap

22 protruding member

24 anchor

26 gap

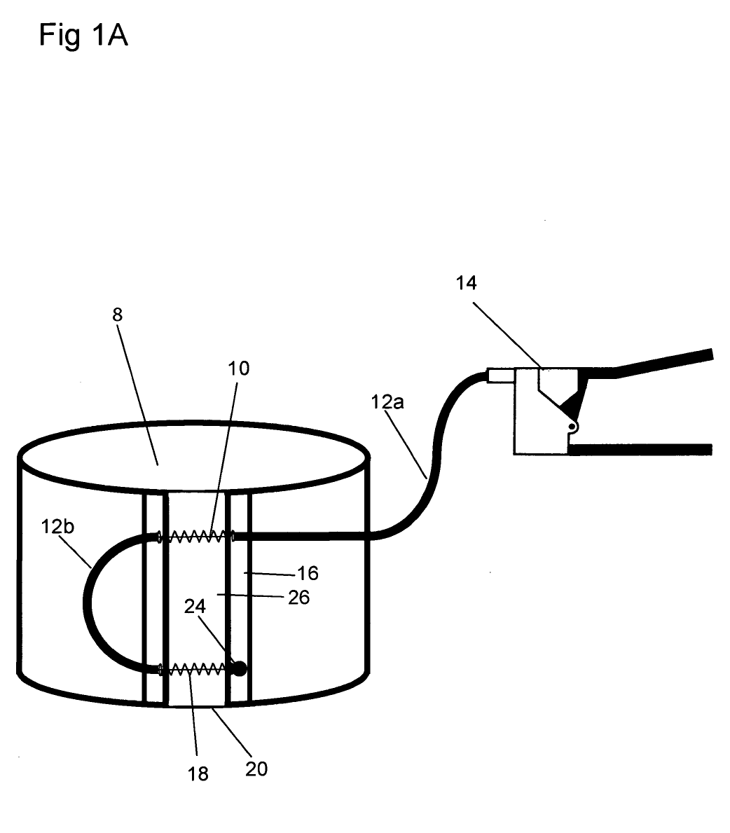

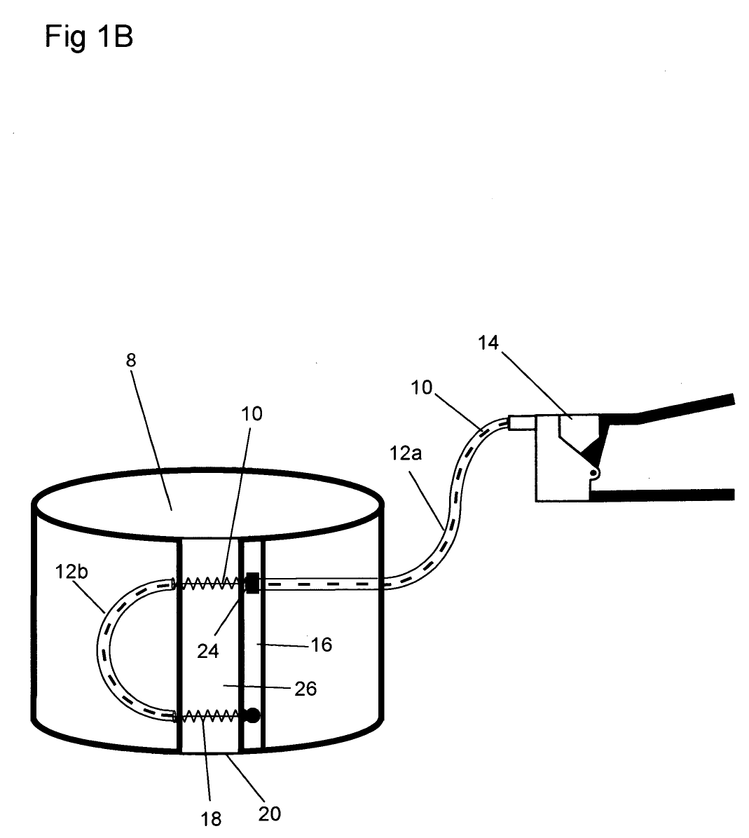

### DETAILED DESCRIPTION—FIRST EMBODIMENT—FIG. 1A

One embodiment of the massage device is illustrated in FIG. 1A. this embodiment consists of a wrap 8, which I envision being constructed of a soft flexible material such as nylon, but any other soft material such as, but not limited to, canvas or polyester can be used. In addition, a semi-soft material such as, but not limited to, rubber or leather, or hard material such as, but not limited to, metal or plastic, can also be used.

The wrap 8 is constricted or compressed by one or more tension-transfer members 10, hereafter referred to as a cable 10. In this embodiment, I envision a thin cable, but wire, string, or lace can also be used. In this embodiment, as shown in FIG. 1A, a single cable is shown, but any number of cables can be used.

The cable 10 is attached to a manual retracting device 14, hereafter referred to as an actuator 14. In this embodiment, the actuator 14 is shown as a mechanism similar to the traditional hand-brake found on a bicycle, as shown in FIG. 1A, but any mechanism which can be manually operated to retract the cable 10 can be used.

In this embodiment, a gap 26 is left between the edges of the wrap 8 along the vertical axis to allow the wrap 8 to constrict when pressure is applied to the actuator 14. I envision a gap 26 of 2 or 3 centimeters, but this can vary depending on the respective leverage of the actuator 14. For wraps 8 made of soft or semi-soft materials, one or more straight or curved wrap supporters 16 can be attached to the edges of the wrap 8 along the vertical axis to allow for even compression and so the wrap 8 will not “pucker” along the vertical edges. for wraps which entirely encircle the body part, supporters are attached a short distance from each other to allow space for compression.

In this embodiment, as shown in FIG. 1A, the cable 10 passes freely through tension-transfer member guides 12a, hereafter referred to as internal guides, extension guides, or inclusively as guides 12a, 12b which are in communication with the wrap 8. The extension guide 12a keeps tension between the actuator 14 and the wrap 8, and the internal guide keeps tension between anchors 24 located on the same side of the vertical gap 26. As shown in FIG. 1A, terminal ends of the guides 12a, 12b are positioned along the vertical edges of the wrap to allow space for compression. In this embodiment, as shown in FIG. 1A, I envision the guides 12a, 12b to be hollow sleeves or tubes, through which the cable 10 passes freely. This can be seen more clearly in FIG. 1B. However, internal guides can be anything which serves to smoothly guide the cable 10 between anchors 24 while keeping tension.

In this embodiment, as shown in FIG. 1A, anchors 24 are separate members which hold the guides 12a, 12b in place while allowing the cable 10 to move freely, but anchors 24 may also be other means of attachment such as glue or sewing. In this embodiment, as shown in FIG. 1A, two springs 18 are positioned between the vertical edges of the wrap 8, which force the the wrap 8 back to its un-constricted position upon release of the actuator 14. However, any number of springs 18 or spring-like objects can be used. As shown in FIG. 1, the springs 18 encircle the cable 10, but the springs 18 or other spring-like objects can be placed anywhere along the vertical axis.

In this embodiment, as shown in FIG. 1A, a protective flap 20 is attached to the wrap 8 along the vertical axis behind the springs 18 to avoid abrasion between the springs 18 and the operator's skin, pants, etc.

### OPERATION—FIRST EMBODIMENT—FIG. 1A

The wrap 8 is placed around a body part such as a limb or appendage. The user then squeezes or depresses the actuator 14, which retracts the cable 10, constricting the wrap 8 by bringing its vertical edges closer together. The guides 12a, 12b keep tension between the actuator 14 and the wrap 8 and between anchors 24. Upon releasing the actuator 8, pressure is released, and the actuator 8, cables 10 and wrap 8 return to the starting, open position. The springs 18 push the wrap 8 completely back to its un-constricted position upon release of the actuator 14. this action can be repeated continuously to produce a massaging effect.

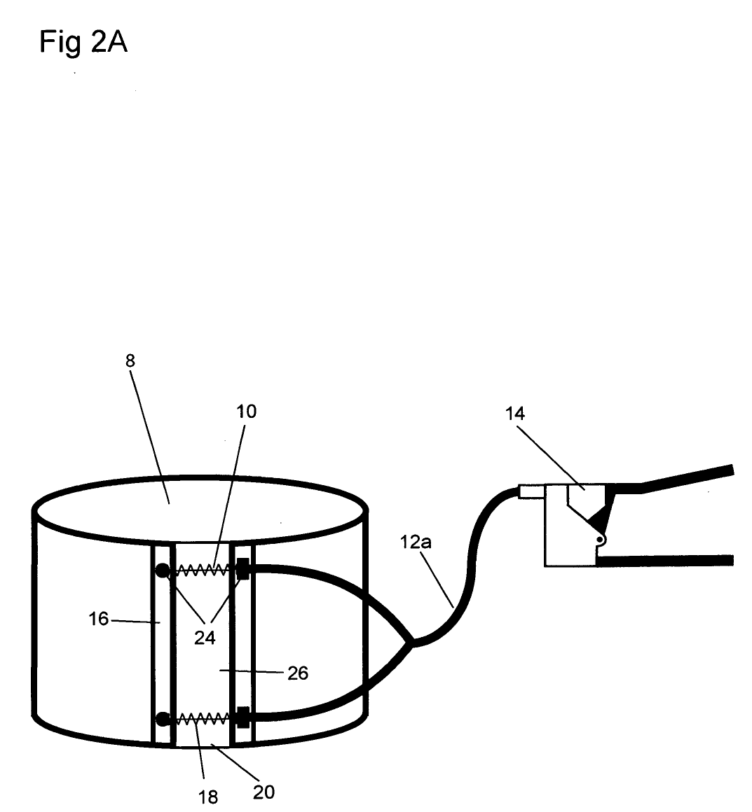

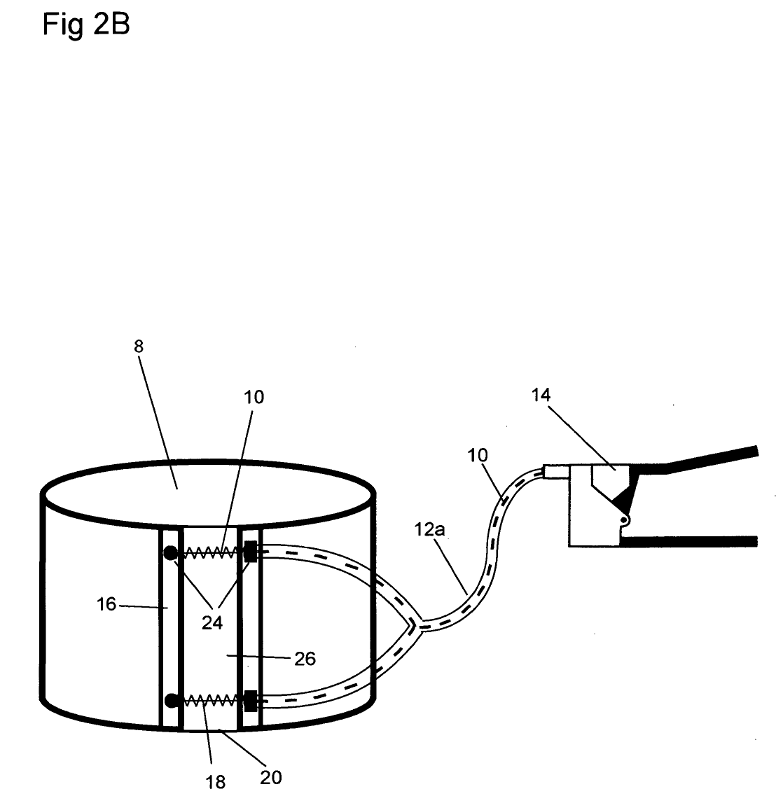

### ALTERNATIVE EMBODIMENTS—FIGS. 2-6

There are many alternative embodiments for this massage device which all rely on the same basic concept and operate in basically the same manner. Any number of tension-transfer members, guides and springs can be used as well as different types of materials for various parts. FIGS. 2A-6 show a few of these embodiments, any of which are viable alternatives.

### DESCRIPTION—ALTERNATIVE EMBODIMENT—FIG. 2

An alternative embodiment is shown in FIG. 2A this embodiment shows two cables 10, each in communication with the wrap 8, and each passing through its own spring 18. Between the wrap 8 and the actuator 14 is a split extension guide 12a. Both split ends of the extension guide 12a are attached to the wrap 8 with anchors 24. between the split of the extension guide 12a and the actuator 14, the tension-transfer members 10 can be either separate, attached or wound together.

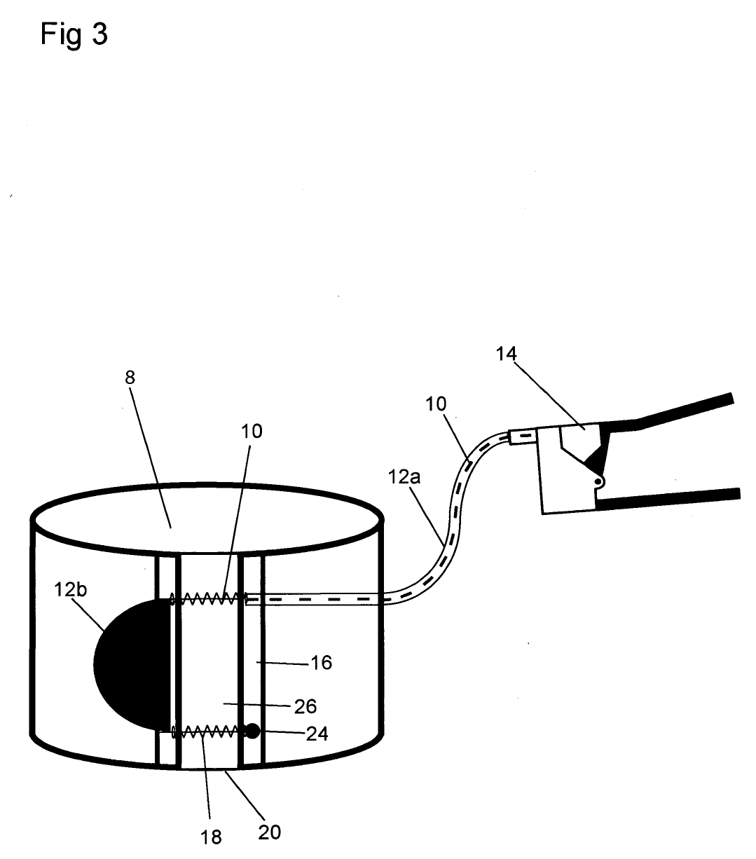

FIG. 3 shows an embodiment with one cable 10 with a grooved internal guide 12b. In this embodiment, I envision the internal guide 12b to be a solid piece with a groove along the edge to allow the cable 10 to slide freely while prohibiting lateral motion, but any hard, smooth material can be used. Alternatively, a grooved wheel, such as a pully, can be used. This embodiment also shows the anchor 24 as a direct attachment to the wrap 8.

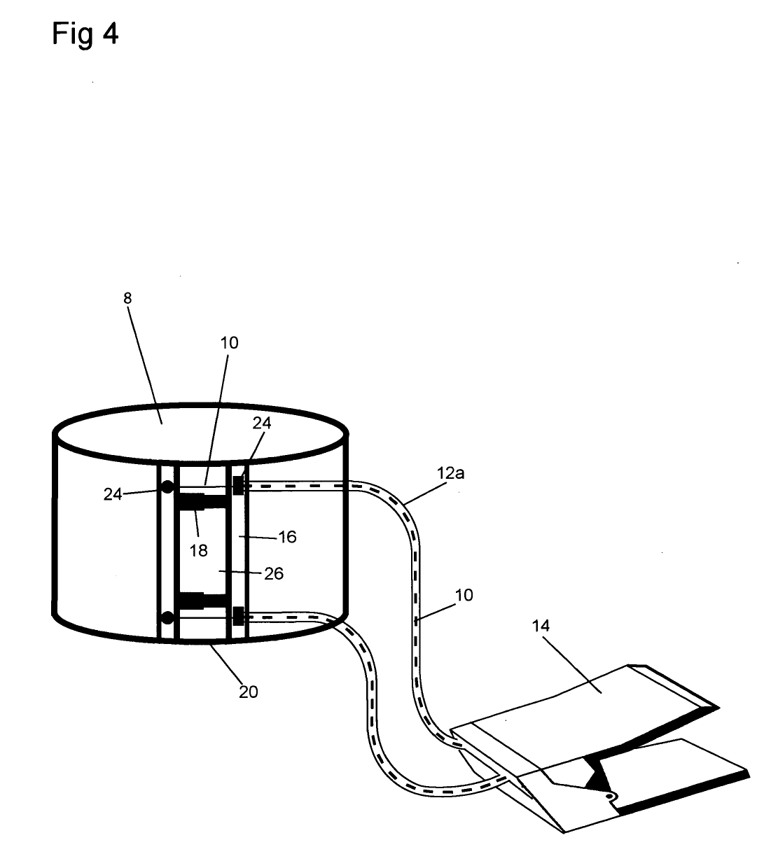

FIG. 4 shows an embodiment with two cables 10, each passing through its own extension guide 12a between the wrap 8 and the actuator 14, and no internal guide. This embodiment also shows encased springs 18 not encircling the tension-transfer members 10, a completely encircling wrap 8, and an actuator 14 wide enough to be operated by foot or be placed on a flat object such as a table.

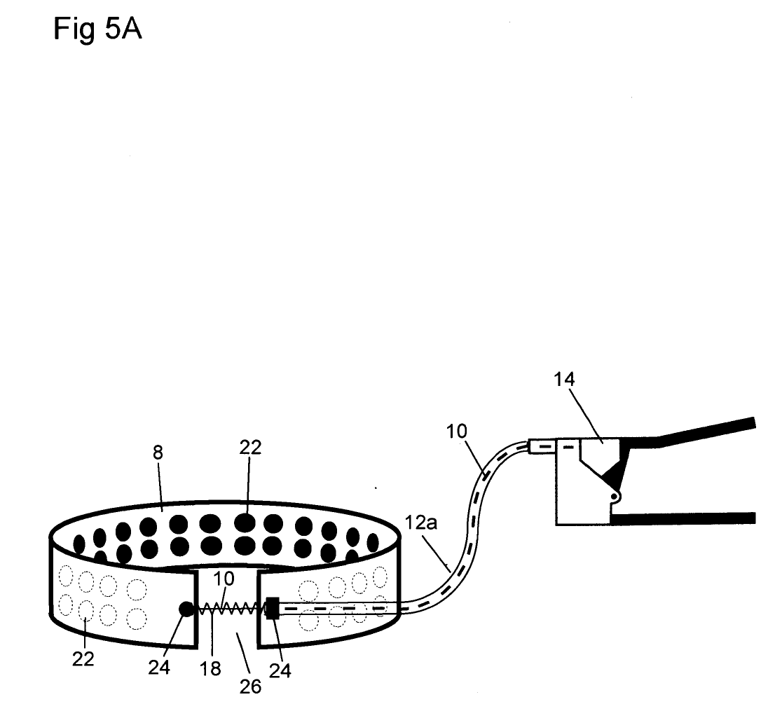

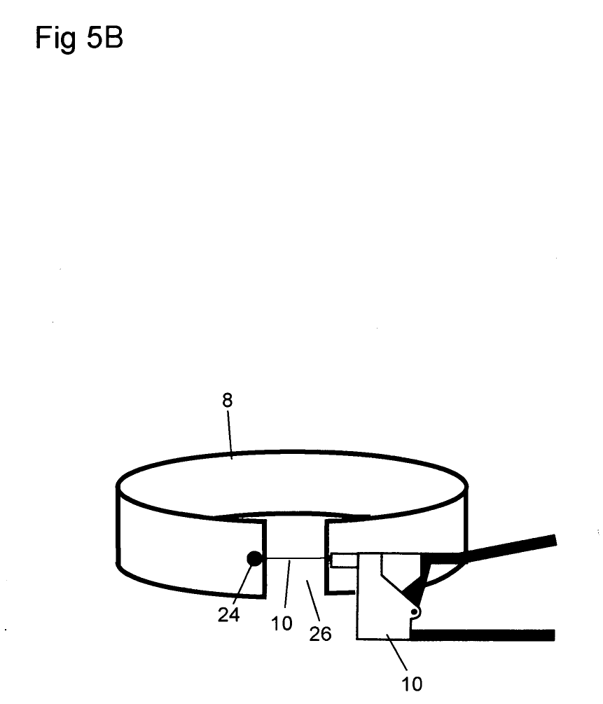

FIG. 5A shows an embodiment with a short, band or belt-like wrap 8 with a single cable 10 and no internal guide. This embodiment also shows protruding members 22, which are attached to the wrap 8 to provide a deeper massage. Any number, size or shape can be used for protruding members.

FIG. 5B shows the simplest embodiment with only one cable 10 and an extension guide 12a.

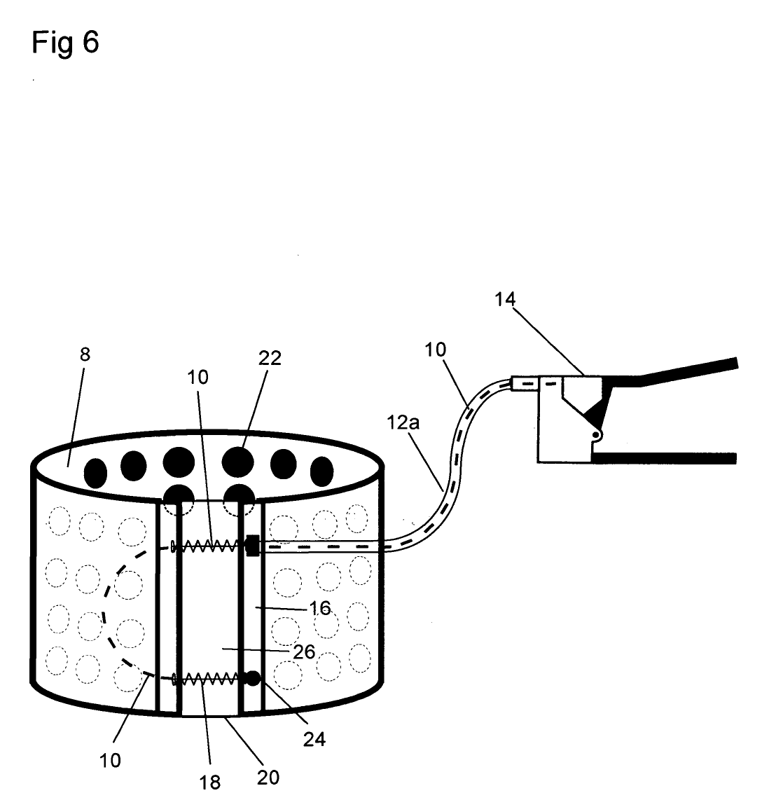

FIG. 6 shows an embodiment with no internal guide as the cable 10 is encased within the wrap 8.

### ADVANTAGES

From the descriptions above, several advantages for some embodiments become evident:

(a) This massage device is easy to use. One need only put the wrap on and apply the actuator.

(b) Being small and lightweight, it is very portable and can be used almost anytime and anywhere.

(c) It can be manufactured using simple materials and parts, most of which are readily available. This means low-cost manufacturing and a low-cost end product.

(d) Being manually operated, either by hand or foot, there is no need for any type of electrical input, not even a battery.

### CONCLUSION, RAMIFICATIONS AND SCOPE

Accordingly, the reader can see that this massage device is portable and easy to use. The user does not have to worry about remembering to charge a battery or bring extra batteries. Being a manual massage device rather than a medical device, the construction is rather simple and inexpensive and easily accessable to the casual user for a reasonable price.

While the above description contains many specificities, these should not limit the scope to the presented embodiments. One can envision any number of more complex, heavy duty versions all based on the same basic concept, all relating back to the appended claims herein.

We claim:

1. A portable massage device comprising a wrap or enclosure, large enough to mostly or entirely encircle a body part such as, but not limited to, a limb, constricted by one or more tension-transfer members which are retracted by a manual actuator.

2. The tension-transfer member or members of claim 1 comprising a cable, wire, string or lace, being in communication with the wrap or enclosure of claim 1.

3. The manual actuator of claim 1 being in communication with the tension-transfer member or members of claim 1.

4. a means to return wrap or enclosure of claim 1 to the un-constricted position upon release of said manual actuator,

5. an extension guide positioned between wrap or enclosure and said manual actuator of claim 1.

6. one or more protruding members in communication with wrap or enclosure of claim 1 to enhance massage effect.

7. protruding members in communication with wrap of claim 1 to enhance massage effect

8. A portable massage device comprising:
a) a wrap or enclosure large enough to mostly or entirely encircle a body part such as, but not limited to, a limb,
b) one or more tension-transfer members which constrict said wrap or enclosure,
c) a manual actuator which retracts said tension-transfer members,
d) a means to return said wrap or enclosure to the un-constricted position upon release of said manual actuator,
e) an extension guide positioned between said wrap or enclosure and said manual actuator,
f) one or more protruding members in communication with said wrap or enclosure to enhance massage effect.

9. The tension-transfer member or members of claim 8 being made entirely or in part of a flexible cable, wire, string or lace with tensile strength sufficient to transfer tension from said manual actuator to said wrap or enclosure.

10. The tension-transfer member or members of claim 8 being in communication with said wrap or enclosure and said manual actuator.

11. The tension-transfer member guide or guides of claim 8 being positioned between and communicating with the actuator of claim 8 and wrap or enclosure of claim 8.

12. The means to return said wrap or enclosure to the unconstricted position of claim 8 comprising one or more springs or spring-like member which resists tension, and which is in communication with the wrap or enclosure of claim 8.

13. The tension-transfer member or members of claim 8 passing through and in slidable communication with the tension-transfer member extension guide or guides of claim 8.

14. A method for massaging appendage muscles:
a. providing a wrap or enclosure, mostly or entirely encircling a body part such as, but not limited to, a limb,
b. providing one or more tension-transfer members in communication with said wrap or enclosure and constricting said wrap or enclosure,
c. providing a manually operated actuator for retracting said tension-transfer member or members.

15. The tension-transfer member or members of claim 14 being in communication with the wrap or enclosure of claim 14.

16. The manual actuator of claim 14 being in communication with the tension-transfer member or members of claim 14.
